(19) United States
(12) Patent Application Publication
(10) Pub. No.: US 2003/0084215 A1
(43) Pub. Date: May 1, 2003

(54) Handwriting and video input function included portable electronic device

(76) Inventor: Chi-Ti Kao, Taipei Hsien (TW)

Correspondence Address: SUPREME PATENT SERVICES, POST OFFICE BOX 2339, SARATOGA, CA, 95070, US

(21) Appl. No.: 10/032,994

(22) Filed: Oct. 29, 2001

(51) Int. Cl. G06F 13/12

(52) U.S. Cl. 710/62

(57) ABSTRACT

A handwriting and video input function included portable electronic device for downloading or uploading data from or to an electronic machine comprises a tablet screen, a multimedia I/O unit, a wireless transceiver unit, and a data I/O controller. The tablet screen is employed to receive tact signals of a stylus, and the multimedia I/O unit includes an audio and/or video signal I/O module for input and output of multimedia A/V signals. The wireless transceiver unit is an infrared ray (IR) transceiver unit composed of an IR transceiver and an IR controller, or a radio transceiver unit, for uploading the input data of the tablet screen or the multimedia I/O unit to an electronic machine and downloading data from the electronic machine. The data I/O controller is a flash memory controller to control the tablet screen, the multimedia I/O unit, and the wireless transceiver unit.

### BACKGROUND OF THE INVENTION

The computer products so far may be classified into three categories: the Desktop computer, the Notebook computer, and the Personal Digital Assistant (PDA). The Desktop computer is generally advantageous in its powerful functions, low cost, unification of parts specifications, convenient upgrade and maintenance, high frequency in updating hardware, etc., while it is awkward in its bulky volume and low portability. The notebook computer is merited in its portability while defective in its high cost, power consumption, nonunification of parts specifications, and low possibility for upgrade. The PDA is better in portability than the notebook computer, combinable with other communication products, nevertheless, it is defective in its high cost, power consumption, short life-cycle period, and insufficient operation capability that fails to satisfy general requirements of multimedia. Therefore, the existing information products do not seem to satisfy those three conditions of consumers: low cost, powerful functions, and high portability, and it is the reason that this invention would propose an electronic device for extending and enlarging the operable space of the Desktop computer.

### SUMMARY OF THE INVENTION

The primary object of this invention is to provide a low cost, high performance, and portable electronic device.

Another object of this invention is to provide an electronic device for extending and enlarging the powerful functions and merits of an existing Desktop computer.

In order to realize above said objects, the portable electronic device of this invention for downloading or uploading data from or to an electronic machine comprises: a tablet screen, a multimedia I/O unit, a wireless transceiver unit, and a data I/O controller.

The tablet screen is employed to receive tact signals of a stylus, and the screen itself could be a tact style LCD panel or a handwriting-input digital tablet.

The multimedia I/O unit includes an audio and/or video signal I/O module for input and output of multimedia A/V signals.

The wireless transceiver unit could be an infrared ray (IR) transceiver unit composed of an IR transceiver and an IR controller, or a radio transceiver unit, for uploading the input data of the tablet screen or the multimedia I/O unit to an electronic machine and downloading data from the electronic machine for output via the multimedia I/O unit.

The data I/O controller could be a flash memory controller to control the tablet screen, the multimedia I/O unit, and the wireless transceiver unit for transmitting data received by the tablet screen or by the multimedia I/O unit to the electronic device via the wireless transceiver unit; or transmitting the data received by the wireless transceiver unit from the electronic device for output via the multimedia I/O unit.

For more detailed information regarding advantages or features of this invention, at least an example of preferred embodiment will be elucidated below with reference to the annexed drawings.

### BRIEF DESCRIPTION OF THE DRAWINGS

The related drawings in connection with the detailed description of this invention to be made later are described briefly as follows, in which:

FIG. 1 shows a schematic view of an embodiment of this invention in mating with a Desktop computer;

FIG. 2 shows a structural block diagram of this invention;

FIG. 3 is an operation flowchart of this invention for input and output of video signals;

FIG. 4 is a flowchart showing operation of a tablet screen of this invention; and

FIG. 5 is an operation flowchart showing wireless transmission of this invention.

### DETAILED DESCRIPTION OF THE INVENTION

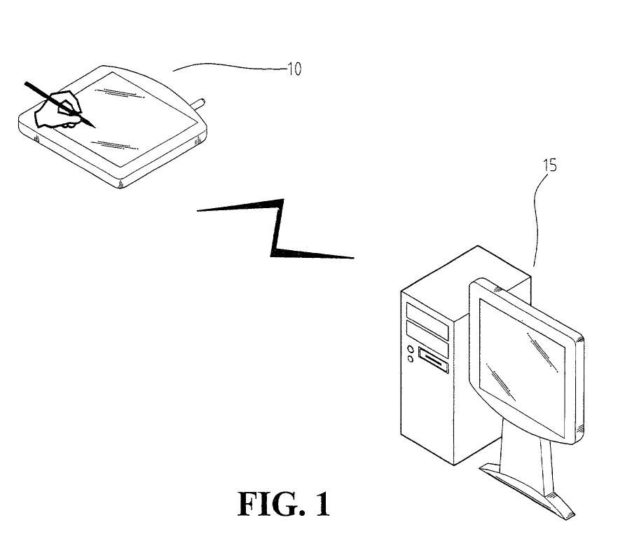

As indicated in FIG. 1—a schematic view showing an embodiment of this invention in mating with a Desktop computer, an electronic device 10 of this invention is employed to download or upload data from or to an electronic machine 15, which could be a Desktop computer capable of transmitting data wirelessly.

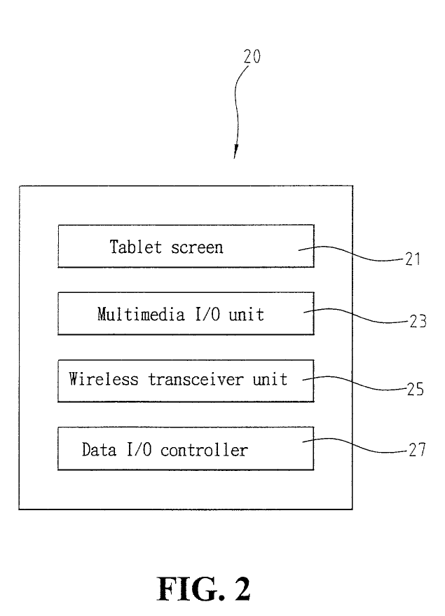

In a structural block diagram of this invention shown in FIG. 2, a portable electronic device 20 comprises a tablet screen 21, a multimedia input/output (I/O) unit 23, a wireless transceiver unit 25, and a data input/output (I/O) controller 27.

The tablet screen 21 is employed to receive tact signals of a stylus, and the screen itself could be a tact style liquid crystal display (LCD) panel or a handwriting-input digital tablet.

The multimedia I/O unit 23 may include an audio and/or video signal I/O module for input and output of multimedia audio/video (A/V) signals.

The wireless transceiver unit 25 could be an infrared ray (IR) transceiver unit composed of an IR transceiver and an IR controller, or a radio transceiver unit, for uploading the input data of the tablet screen 21 or the multimedia I/O unit 23 to an electronic machine and downloading data from the electronic machine for output via the multimedia I/O unit 23.

The data I/O controller 27 could be a flash memory controller to control the tablet screen 21, the multimedia I/O unit 23, and the wireless transceiver unit 25 for transmitting data received by the tablet screen 21 or by the multimedia I/O unit 23 to the electronic machine via the wireless transceiver unit 25; or transmitting the data received by the wireless transceiver unit 25 from the electronic device for output via the multimedia I/O unit 23.

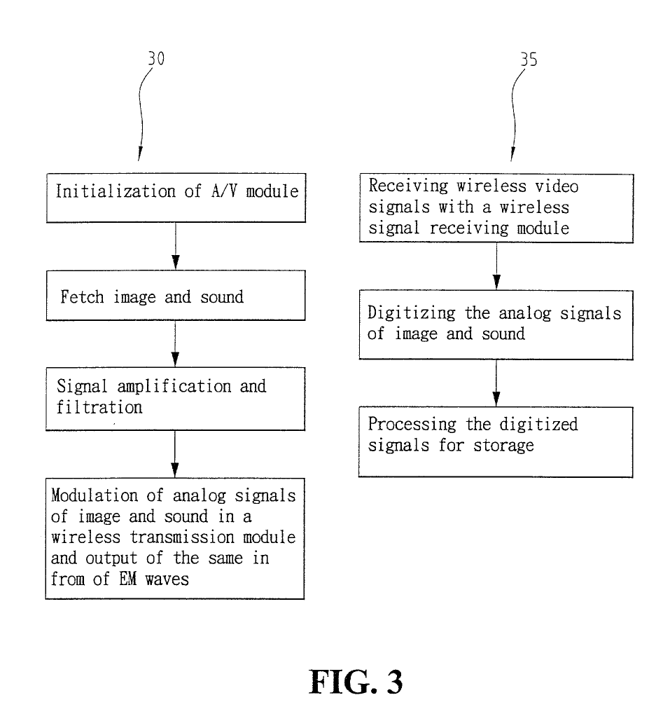

FIG. 3 is an operation flowchart of this invention for input and output of video signals, in which the steps of a portable electronic device of this invention for input and output of video signals with the cooperation of a Desktop computer are shown in a partial flowchart 30 while the video input/output operation of the Desktop computer is shown in another partial flowchart 35. The wireless data transmission way between the portable electronic device of this invention and the Desktop computer could be the way of IR or radio transmission.

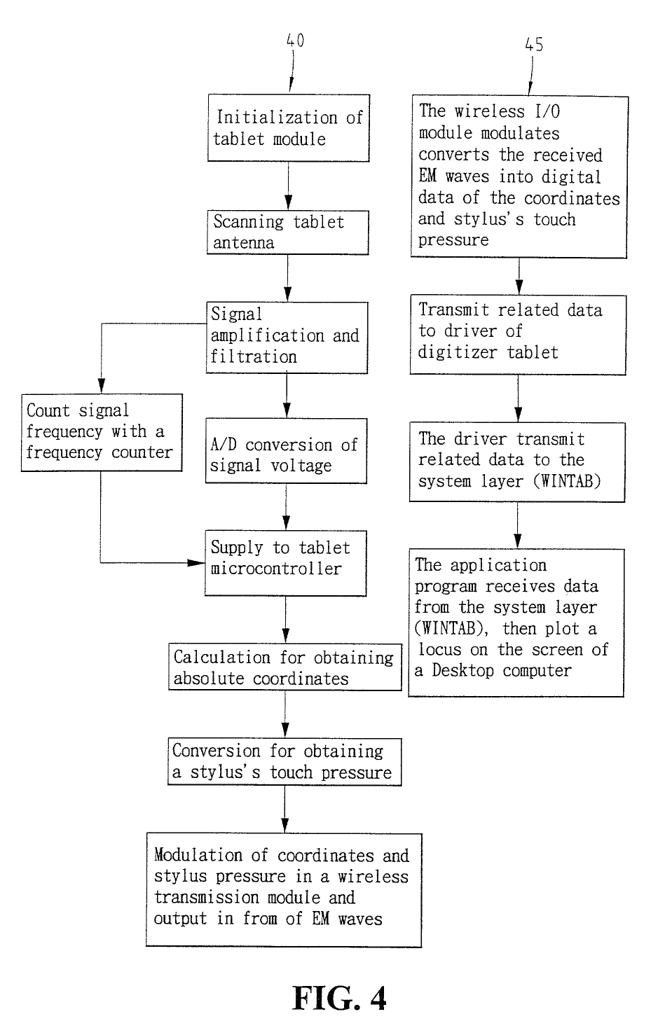

As shown in FIG. 4—a flowchart showing operation of a tablet screen, in cooperation with a Desktop computer, an operation flowchart of a tablet screen of this invention is described in a partial flowchart 40, and the data input/output operation of the Desktop computer is expressed in another partial flowchart 45. A tablet screen of the portable electronic device is employed to receive signals of a LCD tact panel or a digital tablet with stylus, namely input data and coordinates of the stylus, which is then modulated for output in form of, for example electromagnetic waves, by way of wireless transmission to the Desktop computer. Upon receipt of the electromagnetic waves, the Desktop computer is supposed to convert the same into data and coordinates again for further processing or storage.

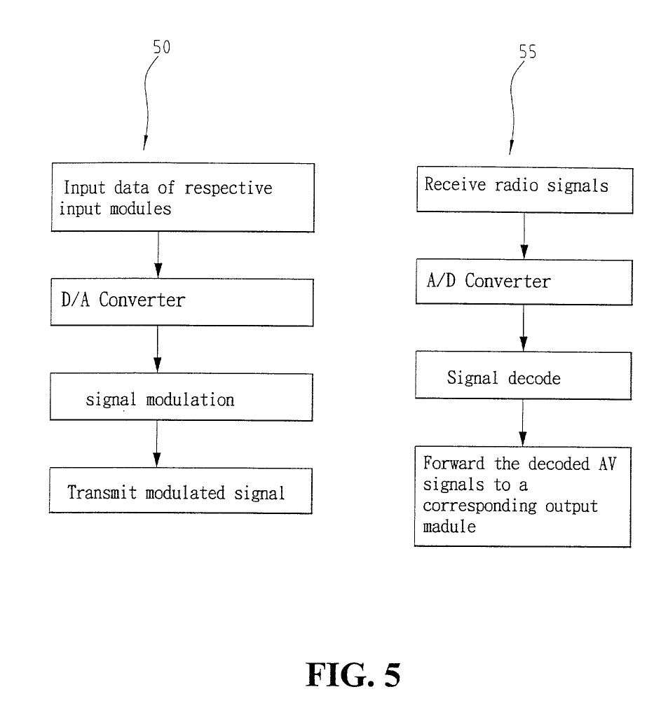

As indicated in an operation flowchart of wireless transmission shown in FIG. 5, this invention is embodied with the cooperation of a Desktop computer, wherein the wireless transmission operation of a portable electronic device of this invention is shown in a partial flowchart 50 while that of the Desktop computer is shown in another partial flowchart 55.

In the above described, at least one preferred embodiment has been described in detail with reference to the drawings annexed, and it is apparent that numerous variations or modifications may be made without departing from the true spirit and scope thereof, as set forth in the claims below.

What is claimed is:

1. A handwriting and video input function included portable electronic device to be employed for downloading or uploading data from or to an electronic machine comprising:
a tablet screen for receiving input signals of a stylus;
a multimedia input/output (I/O) unit for input and output of multimedia audio/video (A/V) signals;
a wireless transceiver unit for uploading received data of the tablet screen or the multimedia I/O unit to the electronic machine and downloading data from the electronic machine for output via the multimedia I/O unit; and
a data input/output (I/O) controller being a flash memory controller employed to control the tablet screen, the multimedia I/O unit, and the wireless transceiver unit for transmitting data received by the tablet screen or by the multimedia I/O unit to the electronic machine via the wireless transceiver unit, or transmitting the data received by the wireless transceiver unit from the electronic device for output via the multimedia I/O unit.

2. The portable electronic device according to claim 1, wherein the electronic machine is a Desktop computer capable of performing wireless data transmission.

3. The portable electronic device according to claim 1, wherein the tablet screen is a tact liquid crystal display (LCD) panel.

4. The portable electronic device according to claim 1, wherein the tablet screen is a handwriting-input digital tablet.

5. The portable electronic device according to claim 1, wherein the wireless transceiver unit is an infrared ray (IR) transceiver unit.

6. The portable electronic device according to claim 5, wherein the IR transceiver unit comprises an IR transceiver and an IR controller.

7. The portable electronic device according to claim 1, wherein the wireless transceiver unit is a radio transceiver.

8. The portable electronic device according to claim 1, wherein the multimedia I/O unit contains a video signal I/O module.

9. The portable electronic device according to claim 1, wherein the multimedia I/O unit contains an audio signal I/O module.

10. The portable electronic device according to claim 1, wherein the data I/O controller is a flash memory controller.
